(19) United States
(12) Patent Application Publication
(10) Pub. No.: US 2016/0360741 A1
(43) Pub. Date: Dec. 15, 2016

(54) FLEXIBLY FASTENED FRAME ELECTRIC INSECT SWATTER

(71) Applicant: Nathan Louis Gordon, Temple City, CA (US)

(72) Inventor: Nathan Louis Gordon, Temple City, CA (US)

(21) Appl. No.: 14/735,205

(22) Filed: Jun. 10, 2015

(51) Int. Cl. A01M 3/02

(52) U.S. Cl. CPC A01M 3/025; A01M 3/02

(57) ABSTRACT

A flexible electric insect swatter comprising one or more frames that are laterally fastened by elastic fasteners that is further proximately fastened to a handle forming an electric circuit used to electrocute an insect. Each frame contains a single layer grid or alternately two or more meshes capable of receiving a charge. The one or more frame arrangement that is connected by elastic fasteners, allows the insect swatter to return back to its original geometry after being struck. In an alternate embodiment, shock-absorbers are attached to the face of every frame.

### CROSS-REFERENCE TO RELATED APPLICATIONS

This application claims priority based on Provisional Patent Application No. 61/998,130 titled, Flexibly fastened frame electric insect swatter filed on 19 Jun. 2014

| Int. Cl. | A01M 3/02 |
|---|---|
| U.S. Cl. | 43/137 |
| Field of search | 43/137, 132.1, 112 |

### BACKGROUND

### Prior Art

The following is a tabulation of some prior art that presently appears relevant:

| Int. Cl. | A01M 3/02 |
|---|---|
| U.S. Cl. | 43/137 |
| Field of search | 43/137, 132.1, 112 |

| | | | |
|---|---|---|---|
| 7,739,830 | June 2010 | Wells | 43/137; 43/132.1 |
| 7,540,112 | June 2009 | Crenshaw | 43/137; D22/124 |
| 6,055,767 | May 2000 | Carter | 43/134, 136, 137 |
| 5,531,436 | October 1994 | Merrick | 43/137; 132.1; 112 |
| 5,269,092 | December 1993 | Cobble | 43/134, 135, 136, 137 |
| 4,910,909 | March 1990 | Johnson | 43/137 |
| 4,905,408 | March 1990 | Wu | 43/136, 137 |
| 4,617,754 | October 1986 | Miley | 43/137 |
| 3,905,146 | September 1975 | Ralston | 43/137; D22/20; D88/2 |
| 3,673,730 | July 1972 | Hegenberger | 43/137 |
| 2,934,851 | May 1960 | Grish | 43/137 |
| 2,881,554 | October 1958 | Laine | 43/137 |
| 1,879,495 | November 1932 | Renwick | |
| 1,179,303 | April 1916 | Hanlon | |

### NON-PATENT LITERATURE DOCUMENTS

Fly-killing device, wikipedia.org (Nov. 20, 2013 11:35 PM), http://en.wikipedia.org/wiki/Flyswatter
Dynazap extendable insect zapper, dynatrap.com (Nov. 20, 2013 11:35 PM), http://dynatrap.com/dynazap/index.html
Winner, Winner, WINesday #5: Dynazap® Extendable Insect Racket Zapper Review+Giveaway!, shesaved.com (Nov. 20, 2013 11:35 PM), http://www.shesaved.com/2012/08/winner-winner-winesday-5-dynazap-extendable-insect-racket-zapper-review-giveaway.html

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention is directed toward electric insect swatters.

### BACKGROUND OF THE INVENTION

What was invented is a flexible electric insect swatter. It is generally well known that flying insects within a building often land on flat surfaces, such as a wall or table, where they cannot be swatted by a traditional electric insect swatters due to their ridged outer frame. To date, traditional electric insect swatters still follow the 1932 Renwick invention described in issued U.S. Pat. No. 1,879,495 along with the 1959 Lime invention described in issued U.S. Pat. No. 2,881,554. Both the Renwick and Laine electric insect swatters contain a ridged outer frame an exoskeleton to contain oppositly charged wire meshes. These traditional electric insect swatters are ridged and the outer frame housing the wire meshes will crack upon being struck on a hard, non-brittle surface. Normally, a person using an electric insect swatter either: 1. strikes the flying insect while in midflight, or 2. gently places the face of the electric insect swatter directly over the insect while it rests on a surface and then wait until the insect travels into the meshes where it is subsequently electrocuted. This limitation can be best illustrated by the Dynazap™ brand electric flyswatter which incorporates the Laine invention along with the Little invention; where the Little invention is described in issued U.S. Pat. No. 4,120,114.

The Dynazap™ invention incorporates a pre-set extendable handle along with a pre-set swivel in its design. It must be noted that the Renwick, Laine and Dynazap™ inventions cannot be used to strike an insect on a hard surface without causing significant damage to the electric flyswatter due to its ridged frame design. It should be further noted that the Dynazap™ handle—swivel arrangement must be pre-set and that the handle-swivel on the Dynazap™ does not automatically spring back, but rather it must be pre-set in a fixed position by the user before each use. Each of these inventions has limitations which have prevented them from becoming widely used.

Accordingly, it is a principal object of this invention to provide an electric insect swatter that is flexible enough in nature to strike an insect on hard non-brittle surfaces.

### BRIEF SUMMARY OF THE INVENTION

The embodiments discussed herein generally relate to electric flyswatters that are flexible. Referring to the figures, alternate embodiments will now be described. The alternate embodiments are provided to illustrate the embodiments and should not be construed as limiting the scope of the embodiments.

The disclosure herein is an electric insect swatter for electrocuting an insect resting on a surface or while in flight. The term “insect” is taken to mean any flying or crawling insect, including but not excluding: flies, mosquitoes, wasps, bees, ants, roaches, and spiders that are common pests. The flexible electric insect swatter of this invention is formed from one or more frames fastened by elastic fasteners attached to a handle forming an electrical circuit.

A unique feature of this electric insect swatter is that the arrangement of frames and elastic fasteners allow, for flexion, and this arrangement will facilitate striking an insect on a surface without cracking or breaking the insect swatter. The flexibility of the multiple frame arrangement is accomplished by utilizing elastic fasteners in conjunction with electrical wires so that the meshes or alternately the grids within the frames are electrically connected. In still another alternate embodiment, the electrical wires, rather than being welded to the mesh or rod as in previous embodiments, are connected to the mesh or rod by a slip ring. The slip ring allows the electrical wire to slide relative to the mesh or rod when the frames are being bent relative to each other. One purpose of the slip ring is to prevent the weld from breaking away from the wire and mesh (or rod) when repeated stresses are applied the wire and mesh (or alternately to the rod). It should be noted that the slip ring could be formed by looping one end of the electrical wire onto itself and that it is not necessary to attach a separate piece to the electrical wire. The frames and elastic fasteners allow the insect swatter to return back to its original shape after being deformed when striking a surface. This synergism of utilizing multiple frames laterally attached by elastic fasteners in an insect swatter allows for the flexibility found in a traditional flyswatter combined with the benefits of electricity for killing a fly on a surface or while in the air.

Another unique feature of an alternate embodiment of this electric flyswatter invention is that the arrangement of frames is connected to a handle by an elastic fastener. The elastic fastener is employed to allow the frame or alternately the arrangement of frames to bend relative to the handle and to automatically return back straight to its original position relative to the handle.

The “elastic fastener” which also acts as a flexible-hinge could be comprised of one or a combination of the following: 1. a spring-pivot-hinge; 2. shape memory materials (thermal); 3. shape memory materials (pseudo-elastic); 4. materials capable of elastic (reversible) deformation including woods, plastics, foams, rubbers and some metals; and 5. a single spring or an arrangement of springs.

The elastic fastener which is composed of either thermal or pseudo-elastic shape memory alloy could also double as an electrical wire. The shape memory alloy could also be employed to double as both an electrical wire and as an elastic fastener to attach each frame together. Furthermore, the shape memory alloy could be employed to attach a frame to the handle while at the same time forming an electrical circuit.

The “shock absorbers” can be made from materials capable of elastic (reversible) deformation including but not excluding: woods, plastics, foams, rubbers, cork, fabric, and springs.

The electric insect swatter is constructed so that after striking an insect on a surface the arrangement of frames (or a single frame) and the handle will return back to their original position.

Another unique feature in the alternate embodiments, is that elastic shock-absorbers are attached to either a frame or an arrangement of frames. The elastic shock-absorbers are utilized to soften the impact after the frame has made contact with a hard surface. The flexible electric insect swatter is constructed so that an insect is killed by electrocution and not by squashing or compressing.

Further objects and features of the present invention will be apparent to those skilled in the art upon reference to the accompanying drawings and upon reading the following description of the embodiments. A better understanding of the invention will come from the following description and claims taking in conjunction with the attached drawings.

### BRIEF DESCRIPTION OF THE DRAWINGS

Reference in the specification to “an embodiment,” “one embodiment,” “an alternate embodiment,” or “still another embodiment” means that a particular feature, structure, or characteristic described in connection with the embodiments is included in at least some embodiments, but not necessarily all embodiments. The various appearances of “an embodiment,” “an alternate embodiment,” “still another alternate embodiment,” or “still another embodiment” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

FIG. 1 is a perspective view of a flexibly fastened frame electric insect swatter with a multiple frame arrangement and handle shown in a straight position.

FIG. 2 is an exploded perspective view of a flexibly fastened frame electric insect swatter.

FIG. 3 is a perspective view of a flexibly fastened frame electric insect swatter showing a multiple frame arrangement where two frames furthest from the handle are in a bent position.

FIG. 4 is a perspective view of a flexibly fastened frame electric insect swatter showing a multiple frame arrangement where all of the frames are bent relative to each other.

FIG. 5 is a perspective view of a flexibly fastened frame electric insect swatter showing a multiple frame arrangement where the frames are folded into a V shape.

FIG. 6 is a perspective view of a flexibly fastened frame electric insect swatter, showing a multiple frame arrangement, where a frame farthest from the handle is bent relative to all other frames.

FIG. 7 is a perspective view of the inner and outer portions of the encasing frame which houses a top mesh, a bottom mesh (not shown), and fasteners.

FIG. 8 is a perspective view of: a mesh, a fastener, and a wire distally connected to a slip ring (where the encasing frame is not shown).

FIG. 9 is an exploded perspective view of: a mesh, a fastener, and a wire distally connected to a slip ring (where the encasing frame is not shown).

FIG. 10 is a perspective view of an alternate embodiment of a flexibly fastened frame electric insect swatter where a handle is connected to a frame by a fastener.

FIG. 11 is a perspective view of an alternate embodiment of a flexibly fastened frame electric insect swatter where a handle is connected to a frame by a fastener where on each of the frame's faces are a plurality of elastic shock absorbers.

FIG. 12 is a perspective view of still another alternate embodiment of a flexibly fastened frame electric insect swatter where a handle is connected to two frames by a plurality of fasteners.

FIG. 13 is a perspective view of still another alternate embodiment of a flexibly fastened frame electric insect swatter where a handle is connected to six frames by a plurality of fasteners where on each of the frame's faces are a plurality of shock absorbers.

### REFERENCE NUMERALS

11 flexibly fastened frame electric insect swatter
12 a frame
12′ an inner encasing frame
12″ an outer encasing frame
13 elastic fastener
14 a handle
15 rods
16 a single layer grid
17 top mesh
18 bottom mesh
19 elastic shock absorbers
20 electrical wires
21 slip ring

### DETAILED DESCRIPTION OF THE PREFERRED EMBODIMENTS

The invention generally relates to flexible electric insect swatters. Referring to the figures, alternate embodiments of the invention will now be described. The alternate embodiments are provided to illustrate the invention and should not be construed as limiting the scope of the invention.

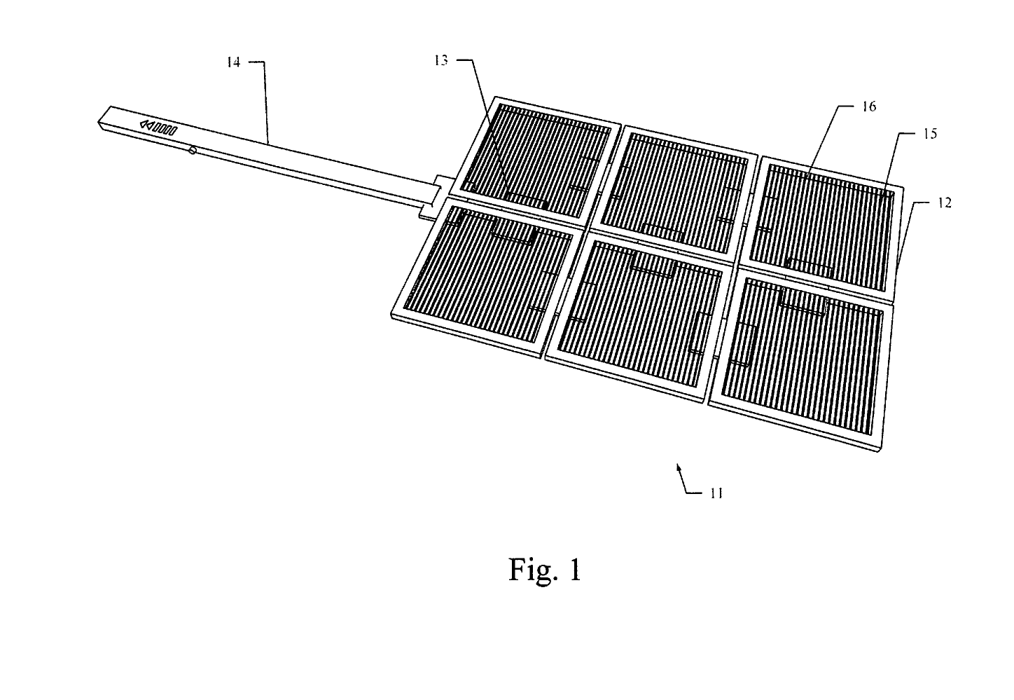

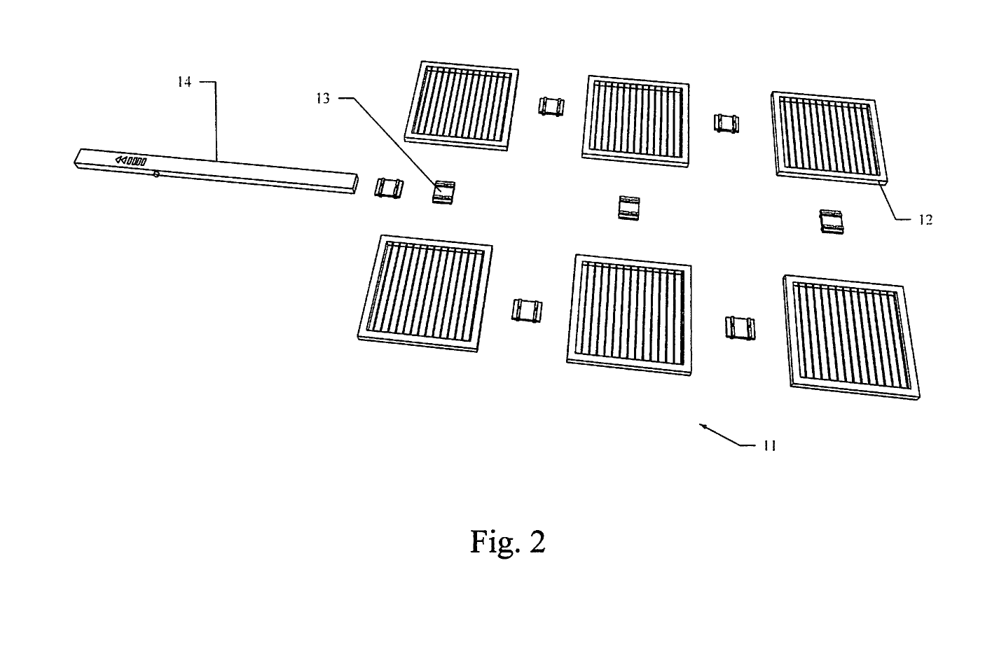

Referring to the drawings FIG. 1 and FIG. 2 an embodiment of a flexibly fastened frame electric insect swatter of this invention is identified with the numeral 11. The flexible fastened frame electric insect swatter contains three basic portions,—that is, one or more frames 12, laterally connected by elastic fasteners 13, where the multiple frame assembly is connected by elastic fasteners to a handle 14 to form an electrical circuit. Within frame 12 are rods 15, laterally spaced to form a grid 16; or alternately, within frame 12 are two or more meshes that are distally spaced.

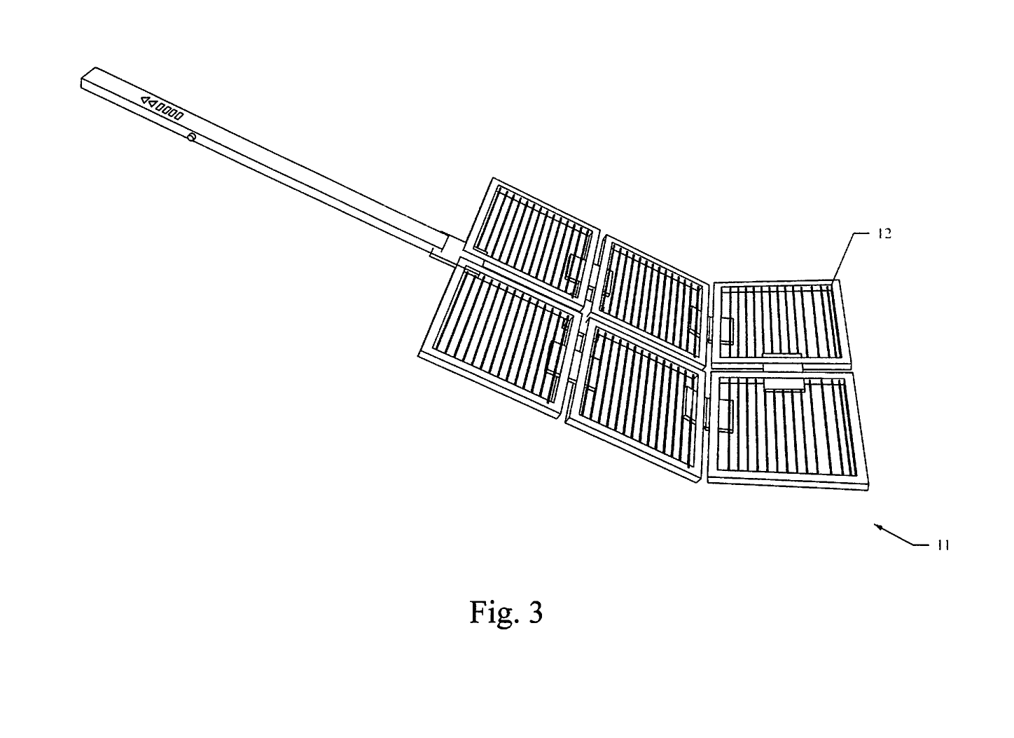

FIG. 3 is a perspective view of a flexibly fastened frame electric insect swatter 11 showing a multiple frame arrangement 12 where two frames furthest from the handle are in a bent position.

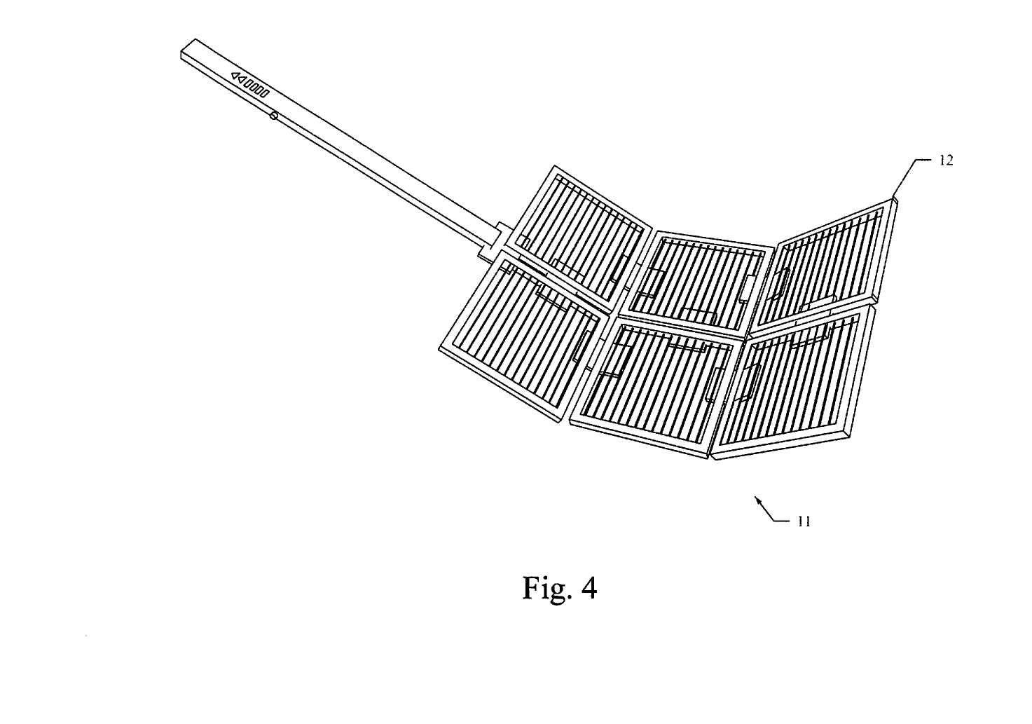

FIG. 4 is a perspective view of a flexibly fastened frame electric insect swatter 11 showing a multiple frame arrangement 12 where all of the frames are bent relative to each other.

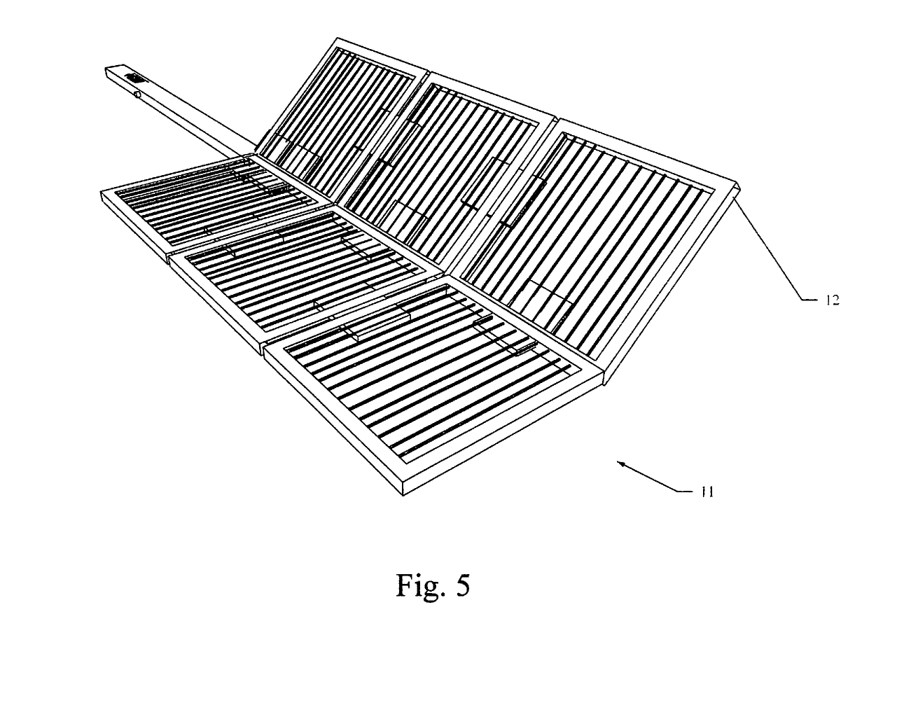

FIG. 5 is a perspective view of a flexibly fastened frame electric insect swatter 11, showing a multiple frame arrangement 12, where the frames are folded into a V shape.

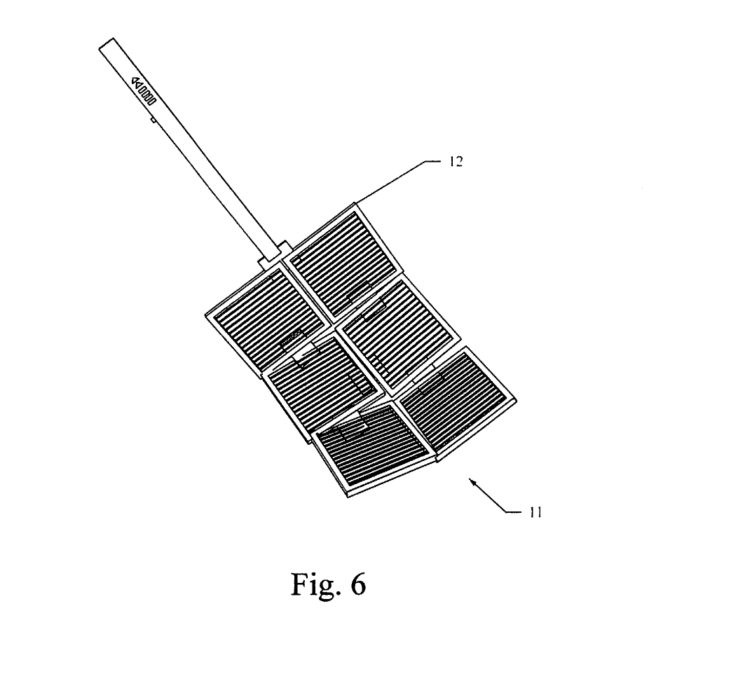

FIG. 6 is a perspective view of a flexibly fastened frame electric insect swatter 11, showing a multiple frame arrangement 12, where a frame farthest from the handle is bent relative to all other frames.

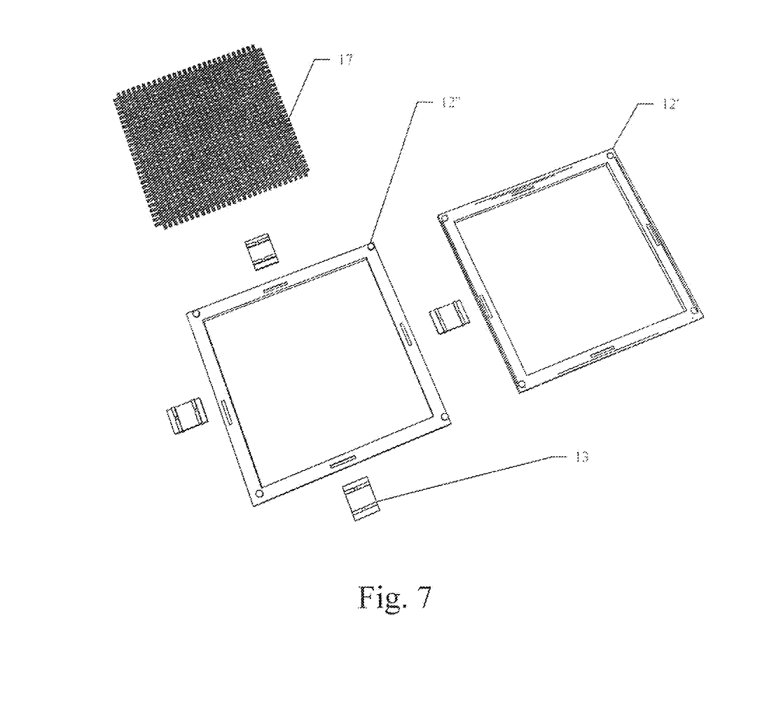

FIG. 7 is a perspective view of the inner and outer portions of the encasing frame (12′ and 12″ respectively), which houses a top mesh 17, a bottom mesh 18 (not shown), and fasteners 13.

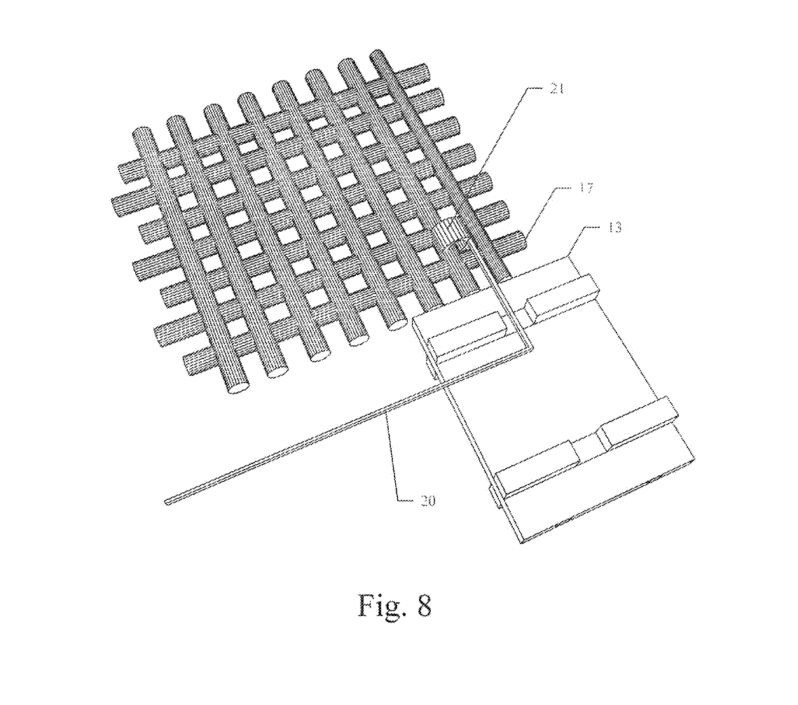

FIG. 8 is a perspective view of a mesh 17, a fastener 13, and a wire 20 distally connected to a slip ring 21 (where the encasing frame is not shown).

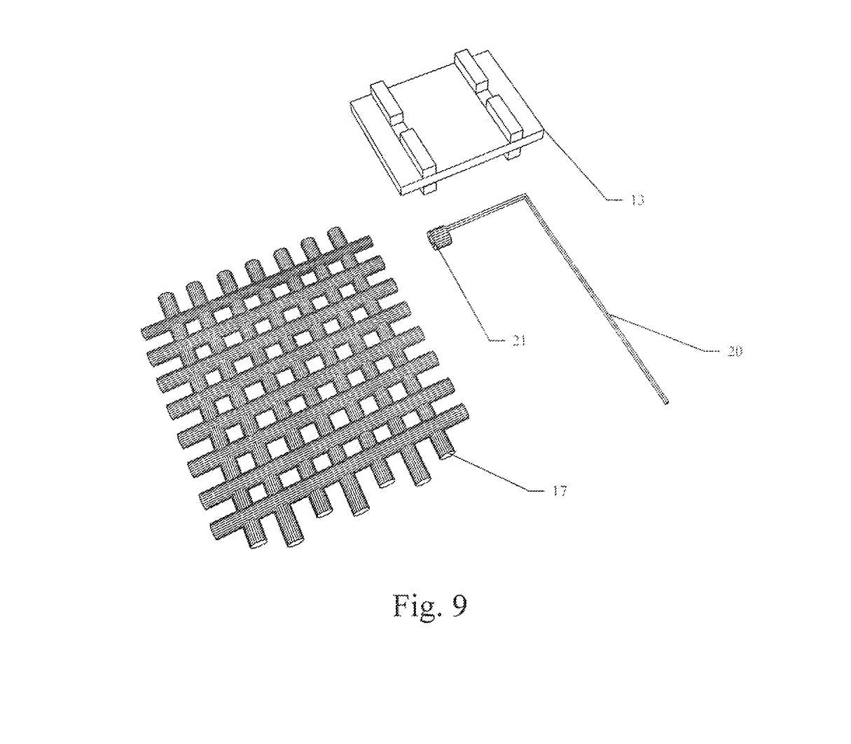

FIG. 9 is an exploded perspective view of: a mesh 17, a fastener 13, and a wire 20 distally connected to a slip ring 21 (where encasing frame 12 is not shown).

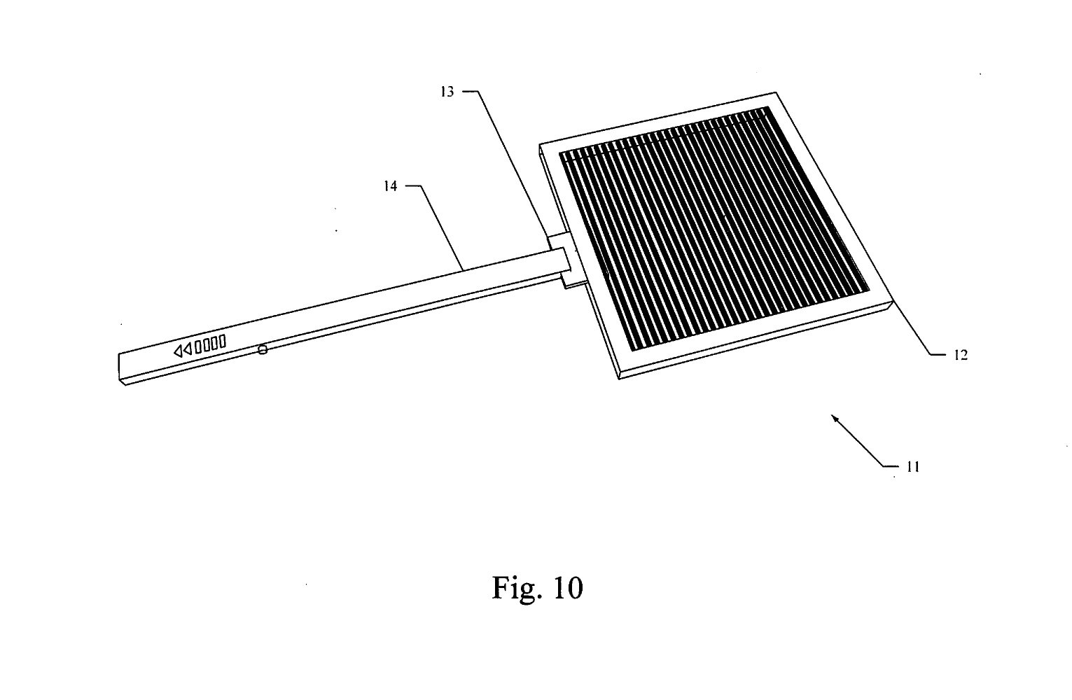

FIG. 10 is a perspective view of an alternate embodiment 11 of a flexibly fastened frame electric insect swatter, where a handle 14 is connected to a frame 12 by a fastener 13.

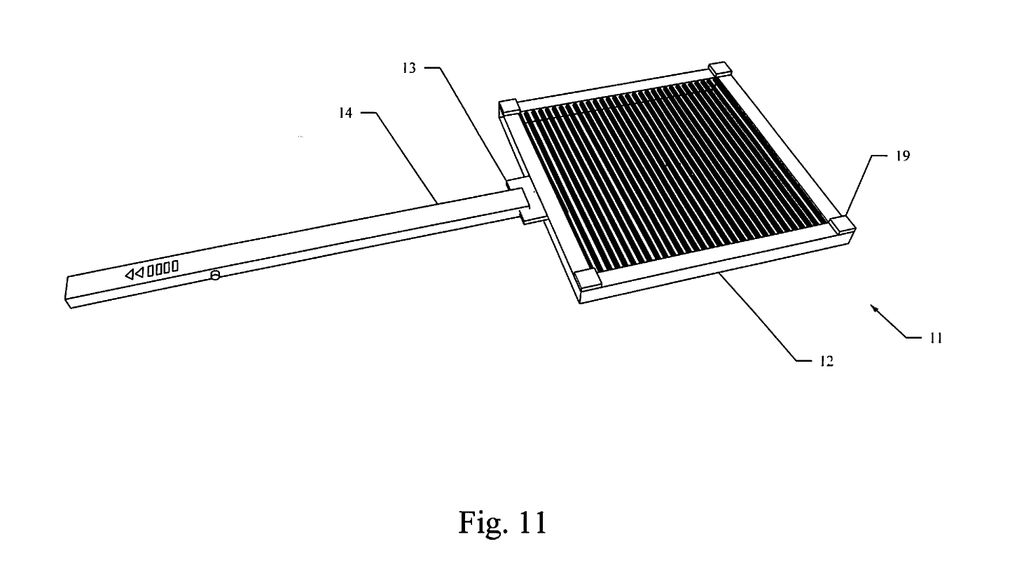

FIG. 11 is a perspective view of an alternate embodiment 11 of a flexibly fastened frame electric insect swatter where a handle 14 is connected to a frame 12 by a fastener 13 where on each of the frame's faces are a plurality of elastic shock absorbers 19.

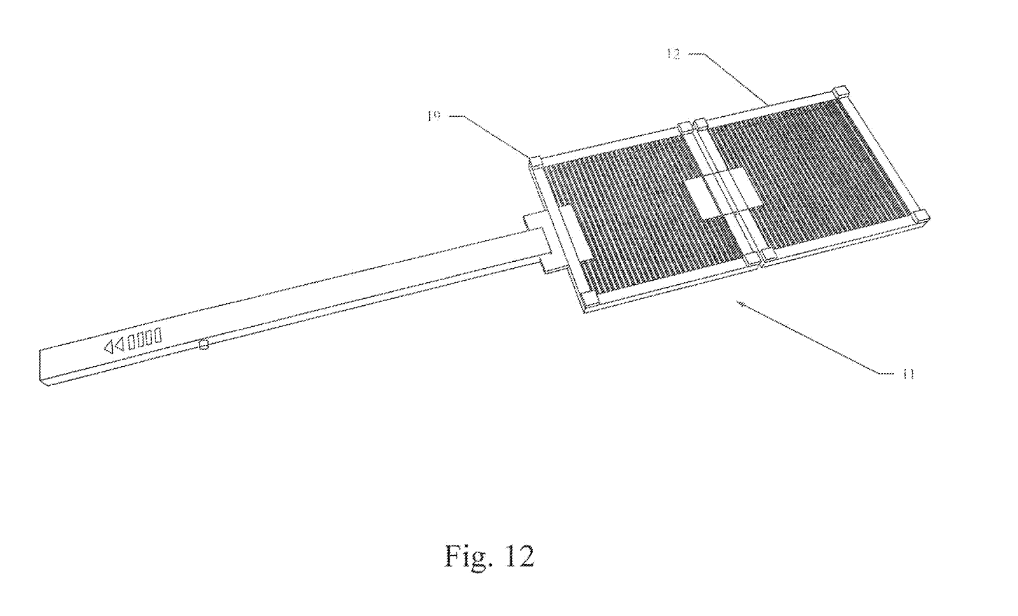

FIG. 12 is a perspective view of still another alternate embodiment 11 of a flexibly fastened frame electric insect swatter where elastic shock absorbers 19 are located on the face of the frames 12.

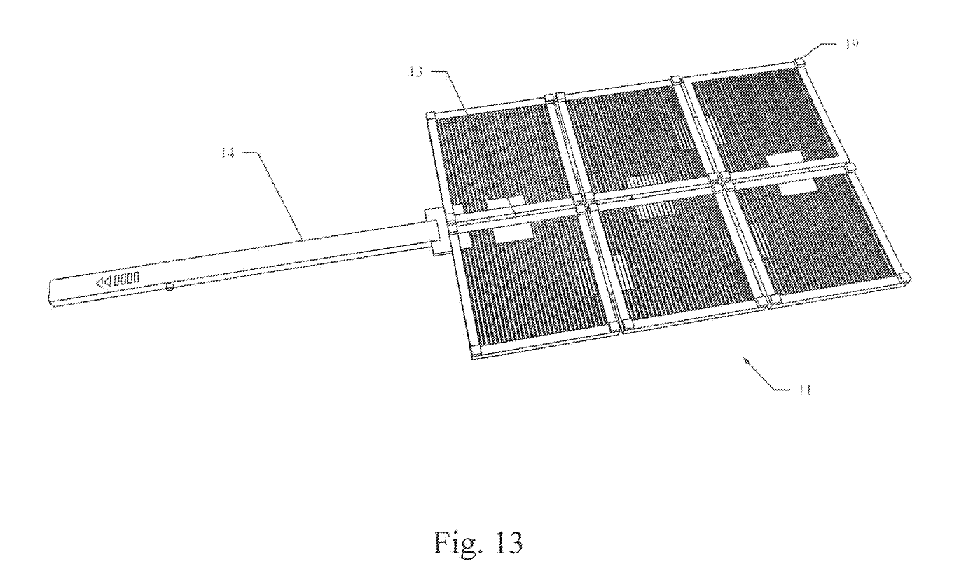

FIG. 13 is a perspective view of still another alternate embodiment 11 of a flexibly fastened frame electric insect swatter where a handle 14 is connected to six frames by a plurality of fasteners 13 where on each of the frame's faces are a plurality of shock absorbers 19.

Within the handle 14 is a power source and a high voltage generator. The high voltage generator normally comprises two main parts: an inverter and a voltage multiplier. However, the power source need not be limited to inverters and voltage multipliers. The power source could be comprised of many techniques any of which is capable of placing an electrical charge onto the rods or alternately the meshes. The power source, high voltage generator and meshes within the frames, or alternately rods within the frames, forms an electrical circuit. This electrical circuit electrocutes an insect when an insect makes contact with two electrified meshes or alternately when the insect touches two of the electrified rods. Also, a power switch could be located either on the handle or on one of the frames.

Furthermore, it should be noted that the elastic fastener 13 need not be hollow. It must also be noted that the elastic fastener 13 need not: encapsulate, hold, or contain any electrical wires 20. Any multiple frame electric insect swatter, where one or more frames are laterally connected by elastic fasteners would be within the scope of this invention.

While certain alternate embodiments have been described and shown in the accompanying drawings, it is to be understood that such embodiments are merely illustrative of and not restrictive on the broad invention, and that this invention should not be limited to the specific constructions and arrangements shown and described, since various other modifications may occur to those ordinarily skilled in the art.

What is claimed is:

1. An electric insect swatter comprising:
(a) two or more frames that are fastened by a plurality of elastic fasteners;
(b) such that the fastened frames are further fastened to a handle;
(c) where the handle and frames are further connected by electrical wires to form an electrical circuit.

2. The electric insect swatter as recited in claim 1, wherein a plurality of elastic shock absorbers are located on the face of each frame.

3. The electric insect swatter as recited in claim 1, where contained within the frame is a plurality meshes proximally and distally spaced where a mesh is connected to an electrical wire by a slip ring.

4. The electric insect swatter as recited in claim 1, where contained within the frame is a grid composed of connected rods laterally spaced where a rod is connected to an electrical wire by a slip ring.

5. A flexible electric insect swatter comprising:
(a) one or more frames;
(b) wherein a frame is further attached to a handle;
(c) by one or more elastic fasteners;
(d) where the frame, handle, and elastic fasteners are further connected by electrical wires to form an electrical circuit.

6. The electric insect swatter as recited in claim 5, wherein elastic shock absorbers are located on the face of a frame.

7. The electric insect swatter as recited in claim 5, where contained within the frame is a plurality meshes proximally and distally spaced where a mesh is connected to an electrical wire by a slip ring.

8. The electric insect swatter as recited in claim 5, where contained within the frame is a grid composed of connected rods laterally spaced where a rod is connected to an electrical wire by a slip ring.

9. An electric insect swatter comprising:
(a) at least two frames but not more than eight frames;
(b) where the frames are fastened by a plurality of elastic fasteners;
(c) such that the fastened frames are further fastened to a handle by one or more elastic fasteners;
(d) where the handle and frames are connected to form an electrical circuit.

10. The electric insect swatter as recited in claim 9, where contained within the frame is a mesh that is connected to an electrical wire by a slip ring.

11. The electric insect swatter as recited in claim 9, where contained within the frame is a grid composed of connected rods laterally spaced where a rod is connected to an electrical wire by a slip ring.

12. The electric insect swatter as recited in claim 9, where elastic shock absorbers are located on the face of each frame.
